(19) United States
(12) Patent Application Publication
(10) Pub. No.: US 2006/0028604 A1
(43) Pub. Date: Feb. 9, 2006

(54) Liquid crystal display device

(75) Inventor: Chen-Yu Liu, Kuei Shan Hsiang (TW)

Correspondence Address: BACON & THOMAS, PLLC, 625 SLATERS LANE, FOURTH FLOOR, ALEXANDRIA, VA, 22314, US

(73) Assignee: Quanta Display Inc., Kuei Shan Hsiang (TW)

(21) Appl. No.: 11/174,724

(22) Filed: Jul. 6, 2005

(30) Foreign Application Priority Data
Jul. 19, 2004 (TW) 093121458

(51) Int. Cl. G02F 1/1343

(52) U.S. Cl. 349/141

(57) ABSTRACT

The present invention discloses a liquid crystal display device, comprising a pair of upper and lower substrates and a liquid crystal layer interposed between the substrates. A plurality of thin film transistors, video signal lines, scan signal lines, common lines, pixel electrodes and counter electrodes are formed over one substrate surface, where the pixel electrodes and the counter electrodes are alternately arranged and their starting points and end points are positioned on one side of a pixel region defined by the video signal lines and the scan signal lines. A transparent auxiliary electrode is formed on the other substrate surface, having a voltage as that of the counter electrodes. A liquid crystal display device so constructed has not only electric fields generated in a plane partly parallel with the substrate but also electric fields generated in a plane substantially perpendicular to the substrate. The transmittance of the substrates of a component is improved.

### BACKGROUND OF THE INVENTION

1. Field of the Invention

The present invention relates to a liquid crystal display device, and more particularly to an active-matrix liquid crystal display device.

2. Description of Related Art

The alignment orientation of liquid crystal molecules of a liquid crystal display (LCD) is controlled by supplying an electric field to the liquid crystal molecules. In other words, when the direction of the electric field is changed, the alignment direction of the liquid crystalsis also changed. Image data is displayed by incident light, due to the optical anisotropy and polarization properties of the liquid crystal molecules.

In a conventional liquid crystal display, the liquid crystal molecules are aligned by applying a vertical electric field, so as to have advantages of high transmittance and high aperture ratio. However, there is also a disadvantage of a narrow viewing angle. In this connection, an in-plane switching (IPS) LCD panel was developed. The IPS LCD uses a lateral electrodes to generate an electric field in a plane parallel with a substrate because pixel electrodes and common electrodes are formed on the same substrate. Hence, the IPS LCD has advantages of a wide viewing angle and low color dispersion.

In general, the ISP LCD display device includes an upper substrate and a lower substrate parallel with each other and a liquid crystal layer interposed between the upper and lower substrates. Pixel electrodes and common electrodes formed together on the lower substrate are parallel with each other and spaced apart from each other. The horizontal electric field between the pixel electrode and the common electrode twists the liquid crystals in the longitudinal axis direction of the liquid crystal. A typical IPS LCD display is disclosed in U.S. Pat. No. 6,266,117, entitled “Active-matrix liquid crystal display.” As shown in FIGS. 12a and 12b, a lower substrate 1A has scan signal lines 2 and video signal lines 3 perpendicular to each other and alternately arranged. Also, a thin film transistor (TFT) as indicated by the arrow shown in FIG. 12a, display electrodes 15 and reference electrodes 14 are included within each defined pixel. The display electrodes 15 and the reference electrodes 14 are spaced apart from each other and alternately arranged. In addition, an upper substrate 1B has shield electrodes 31 corresponding to the video signal lines 3 and a light-shielding film 30 around the periphery of each of the pixels. The display electrodes 15 are commonly known as pixel electrodes. The reference electrodes 14 are commonly known as counter electrodes. The light-shielding film 30 is commonly known as black matrix (BM). As such, the LCD is capable of generating an electric field E in a plane partly parallel with the substrates to achieve the object of a wide viewing angle.

Even so, improvements over the prior IPS LCDs still can be made with respect to the aperture ratio as a whole and wide viewing angle. Especially, there is a divergence problem in the liquid crystal alignment on the edge of the displays, and also, the liquid crystals above the pixel electrodes are unable to be driven to rotate for alignment. An LCD device of the present invention provides improvements over the IPS LCDs so as to accelerate the response time, increase the transmittance of the panel, achieve a wide viewing angle effect and improve a divergence in the liquid crystal alignment on the edge of the display.

### SUMMARY OF THE INVENTION

A primary object of the present invention is to provide a liquid crystal display device employing an auxiliary electrode to increase the transmittance of the panel by effectively using electric fields in different directions. In addition, a smooth insulation layer of a low dielectric constant is added in designing the pixels to not only increase the evenness of the surface but also indirectly reduce an adverse effect of power lines to the liquid crystals caused by metal lines on the bottom and interference between the electrodes. Moreover, both the pixel electrodes and the counter electrodes can be made of a transparent metal to effectively increase the aperture ratio of the panel.

To achieve the aforesaid object, a liquid crystal display device according to the present invention comprises a first substrate having thin film transistors, video signal lines, scan signal lines, common lines, pixel electrodes and counter electrodes, where the video signal lines and the scan signal lines are arranged in matrix form, every two adjacent video signal lines and every two adjacent scan signal lines define a pixel region within which one of the video signal lines on the border of the pixel region is electrically connected to the source of a thin film transistor within the pixel region, one of the scan signal lines on the border of the pixel region is electrically connected to the gate of the thin film transistor within the pixel region, and one of the pixel electrodes within the pixel region is electrically connected to the drain of the thin film transistor within the pixel region, the common lines and the counter electrodes are electrically connected for controlling a voltage, and the pixel electrodes and the counter electrodes are alternately arranged so that starting points and end points of both the pixel electrodes and the counter electrodes are positioned on one side of the pixel region; a second substrate having a transparent auxiliary electrode on the surface thereof; and a liquid crystal layer interposed between the first substrate and the second substrate.

FIG. 1 illustrates a top view of a pixel region of a liquid crystal display device according to the present invention. The liquid crystal display device comprises a first substrate, a second substrate, and a liquid crystal layer interposed between the first substrate and the second substrate. The liquid crystal layer is formed of either a negative dielectric anisotropic liquid crystal or a positive dielectric anisotropic liquid crystal. A plurality of video signal lines 110 and a plurality of scan signal lines 120 are arranged in matrix form on the first substrate surface for defining a plurality of pixel regions. A thin film transistor (as indicated by the arrow shown in FIG. 1) is formed within each of the pixel regions. The thin film transistors are normally formed at each crossing of the video signal lines 110 and the scan signal lines 120. In each of the pixel regions, one of the video signal lines 110 is electrically connected to the source 132 of the thin film transistor within the pixel region; and one of the scan signal lines 120 is electrically connected to the gate 136 of the thin film transistor within the pixel region; and the pixel electrode 140 within the pixel region is electrically connected to the drain 134 of the thin film transistor. In addition, a common line 150 is electrically connected to a counter electrode 160. The pixel electrodes 140 and the counter electrodes 160 having fork-shaped portions extended into the pixel regions are spaced apart and alternately arranged, in general being horizontally arranged with respect to the video signal lines 110. The common line 150 is generally formed as a non-transparent metal layer which can be positioned elsewhere, for example, on one side of the scan signal lines 120 either crossing over the light transmitting zones of the pixel regions or without crossing over or cutting off the light transmitting zones of the pixel regions. The pixel electrodes 140 and the counter electrodes 160 are alternately arranged and have a strip or zigzag shape or any other shape capable of generating a lateral electric field. It is preferable to have the zigzag shape for reducing a color shift phenomenon. The pixel electrodes 140 and the counter electrodes 160 of the present invention have starting points and end points positioned on one side of the pixel region. Preferably, they are made of a transparent metal composed of indium-tin-oxide (ITO) or indium-zinc-oxide (IZO) to increase transmittance; or alternatively, they are made of a non-transparent metal such as chromium or aluminum.

A transparent auxiliary electrode is formed on the second substrate surface. Preferably, the transparent auxiliary electrode is made of ITO or IZO. The simplest form of the transparent auxiliary electrode is a planar electrode, but may have patterns. Preferably, a color filter is further included between the second substrate and the auxiliary electrode to display various colors. More preferably, a smooth layer is further included between the color filter and the auxiliary electrode to eliminate a difference in level between the respective color layers of the color filter. Even so, the transparent auxiliary electrode may be used to directly achieve the planarization of the second substrate surface without the need for including the smooth layer. In this case, it is subject to the topography of the color filter. Namely, the smooth layer is required if the difference in level of the color filter surface is too obvious. If not, the use of only the transparent auxiliary electrode will be sufficient. In addition, the transparent auxiliary electrode or the smooth layer is capable of preventing metal ions of the color filter from entering the liquid crystal layer. The second substrate can further comprise a black matrix interposed between the second substrate and the color filter. The black matrix is positioned around the periphery of each of the pixel regions to cover gaps among red, green and blue pixels. Thus, fatiguing in sunlight caused by interference between LCD dots is significantly reduced so as to present a more stable and clear image quality. Moreover, due to overlaps among different pixels of the color filter, light shielding can also be effected. Preferably, the transparent auxiliary electrode and the counter electrode of the present invention have the same voltage so that the LCD device has not only an electric field generated in a plane substantially parallel with the substrate but also an electric field generated in a plane substantially perpendicular to the substrate to improve the transmittance of the substrates of a component.

Preferably, the pixel electrodes and the counter electrodes are arranged on the same plane. Even so, they can be disposed on different planes. Preferably, an insulating layer is included between the counter electrodes and the video signal lines. The insulating layer preferably is made of an inorganic material such as aluminum oxide or silicon nitride to provide better protection for the thin film transistor. Nevertheless, the material of the insulating layer is not specifically defined. More preferably, a planarized insulating layer is further included. The planarized insulating layer is preferably made of an organic material to simplify the processing steps and accelerate the planarization effect. Nevertheless, the planarized insulating layer can be made of an inorganic material. As such, the scan signal lines and the common lines are disposed between the planarized insulating layer and the first substrate. The planarized insulating layer increases the evenness of the surface and reduces disordered orientation of the liquid crystals caused by the unevenness of the liquid crystal surface so as to increase luminance. Furthermore, it is preferable that the counter electrodes and the video signal lines adjacent thereto are overlapped.

The pixel electrodes and the counter electrodes of the present invention have starting points and end points, both the electrodes being formed together on the common lines. Thus, the counter electrodes are formed in a shape of “ [symbol] ” around the periphery of the pixel regions, except the fork-shaped portions thereof extending into the pixel regions. The following embodiments are schematically cross-sectional views taken along line A-A′.

Other objects, advantages, and novel features of the invention will become more apparent from the following detailed description when taken in conjunction with the accompanying drawings.

### BRIEF DESCRIPTION OF THE DRAWINGS

FIG. 1 is a top view of a liquid crystal display device according to the present invention.

FIGS. 2a and 2b are cross-sectional views of a liquid crystal display device according to a preferred embodiment of the present invention.

FIGS. 3a and 3b are cross-sectional views of a liquid crystal display device according to a preferred embodiment of the present invention.

FIGS. 4a and 4b are cross-sectional views of a liquid crystal display device according to a preferred embodiment of the present invention.

FIGS. 5a and 5b are cross-sectional views of a liquid crystal display device according to a preferred embodiment of the present invention.

FIG. 6 is a cross-sectional view of a liquid crystal display device according to a preferred embodiment of the present invention.

FIGS. 7a, 7b and 7c are cross-sectional views of a liquid crystal display device according to a preferred embodiment of the present invention.

FIG. 8 is a top view of a liquid crystal alignment disposed between pixel electrodes and counter electrodes when a liquid crystal display device of the present invention is in “OFF” state.

FIG. 9 is a top view of a liquid crystal alignment disposed between pixel electrodes and counter electrodes when a liquid crystal display device of the present invention is in “ON” state.

FIG. 10 is a top view of a liquid crystal alignment disposed on pixel electrodes when a liquid crystal display device of the present invention is in “OFF” state.

FIG. 11 is a top view of a liquid crystal alignment disposed on pixel electrodes when a liquid crystal display device of the present invention is in “ON” state.

FIG. 12a is a schematic view of a conventional in-plane switching liquid crystal display.

FIG. 12bis a cross-sectional view taken along line III-III′ in FIG. 12a illustrating a conventional in-plane switching liquid crystal display.

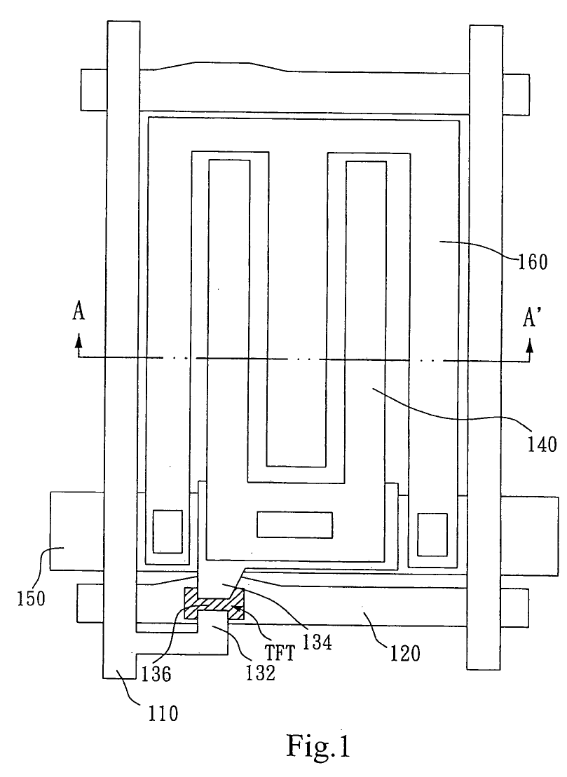

### DETAILED DESCRIPTION OF THE PREFERRED EXAMPLE

Six preferred embodiments of the present invention will now be described to illustrate the technical contents involved in the present invention.

### Embodiment 1

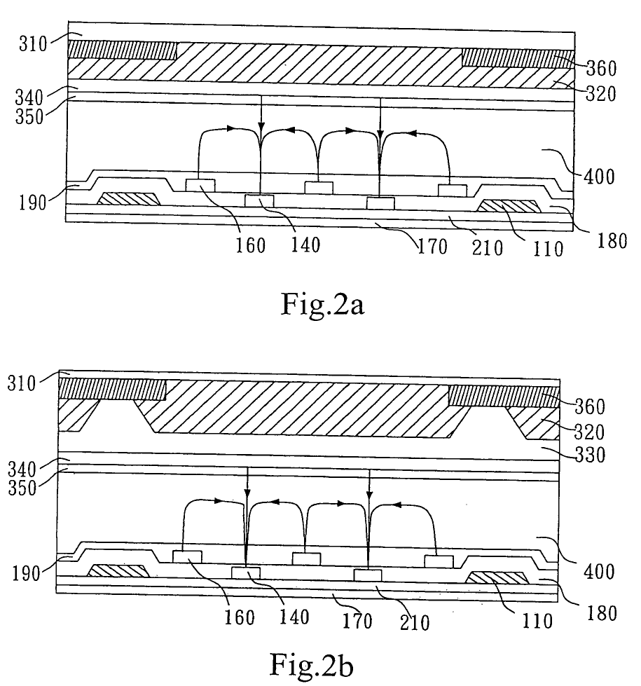

In this embodiment, a liquid crystal device is illustrated in FIG. 2a, in which a color filter 320, a transparent auxiliary electrode 340 and an alignment layer 350 are disposed in order over the surface of a second substrate 310. Furthermore, a black matrix 360 is interposed between the second substrate 310 and the color filter 320, being positioned around the periphery of each of pixel regions. In this embodiment, when there is an obvious difference in level between the color layers, a smooth layer 330 sandwiched between the color filter 320 and the transparent auxiliary electrode 340 is further included so as to eliminate the difference in level between the color layers, as shown in FIG. 2b. Pixel electrodes 140 and video signal lines 110 are formed on the same level over the surface of a first substrate 170. The pixel electrodes 140 and counter electrodes 160 sandwich an insulating layer 180, both the electrodes being made of a transparent metal. In addition, an alignment layer 190 overlays the counter electrodes 160 to be aligned with the alignment layer 350 over the second substrate 310. A gate insulating layer 210 is sandwiched between scan signal lines and the first substrate 170.

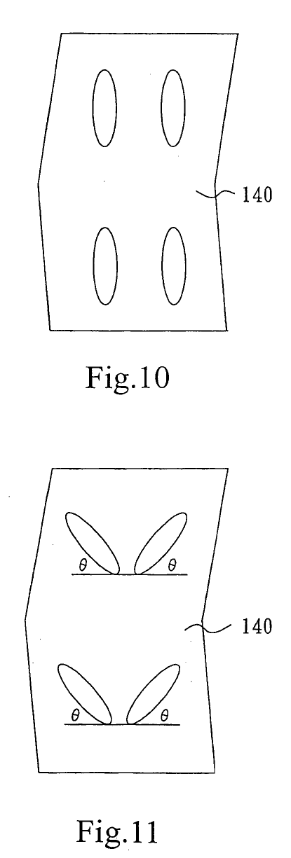

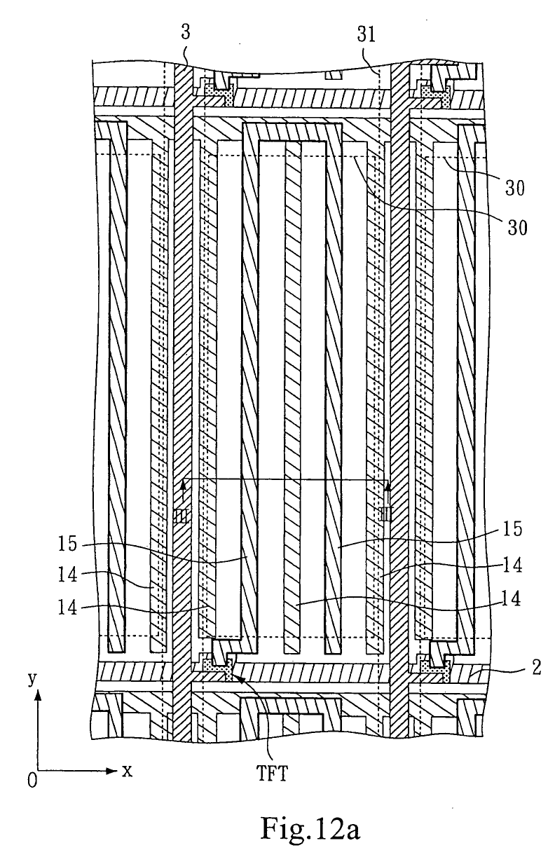

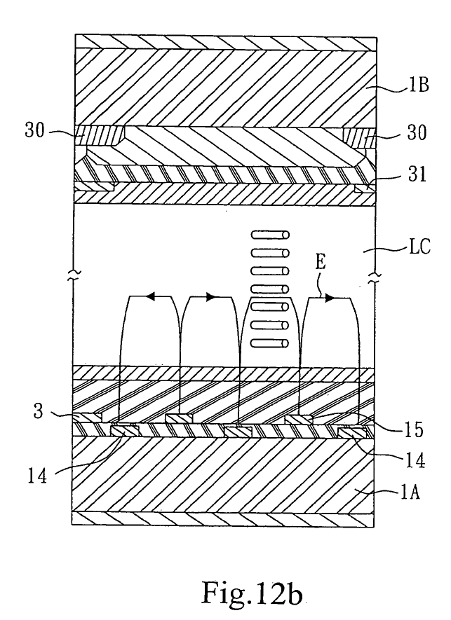

In this embodiment, a voltage applied to the transparent auxiliary electrode 340 is equivalent to that applied to the counter electrodes 160 so that the liquid crystal display device has not only a lateral electric field generated in a plane partly parallel with the substrate as that involved in the conventional liquid crystal display device but also a vertical electric field generated in a plane substantially perpendicular to the substrate above the pixel electrodes 140, distributions of the electric fields being indicated by arrows shown in FIG. 2a. Thus, the transmittance of the substrates of a component is improved. Also, the distribution of the horizontal electric fields of the whole liquid crystal display device is adjustable to solve the divergence problem of the liquid crystals on the edge of the substrate. Taking the conventional same as an example for illustration in detail, the pixel electrodes 140 and the counter electrodes 160 are alternately arranged and have a zigzag shape. The liquid crystals between the pixel electrodes 140 and the counter electrodes 160 are regularly oriented in one direction as shown in FIG. 8 before a voltage is applied. After a voltage is applied, the voltage affects the liquid crystals to become an alignment as shown in FIG. 9. At the same time, the liquid crystals above the front of the pixel electrodes 140 are aligned as the same manner as that when the voltage is applied, however. In other words, application of the voltage will not affect the liquid crystals positioned above the front of the pixel electrodes 140, and thus, no electric field is generated as shown in FIG. 10. In contrast, the liquid crystals positioned above the front of the pixel electrodes 140 will be affected by the auxiliary electrode of the present invention when a voltage is applied. As a result, the liquid crystals rotate at an angle of θ and the aperture ratio increases, as shown in FIG. 11.

### Embodiment 2

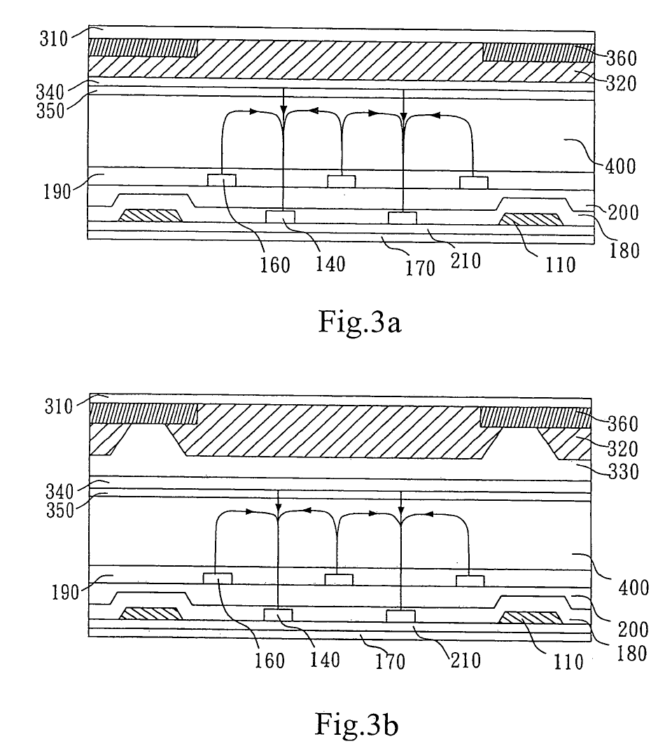

In this embodiment, a liquid crystal device is illustrated in FIG. 3a, in which a color filter 320, a transparent auxiliary electrode 340 and an alignment layer 350 are disposed in order over the surface of a second substrate 310. Furthermore, a black matrix 360 is interposed between the second substrate 310 and the color filter 320, being positioned around the periphery of each of pixel regions. Similar to the first embodiment, this embodiment further comprises a smooth layer 330 interposed between the color filter 320 and the transparent auxiliary electrode 340, as shown in FIG. 3b. Pixel electrodes 140 and video signal lines 110 are formed on the same level over the surface of a first substrate 170. The pixel electrodes 140 and counter electrodes 160 sandwich an insulating layer 180 and a smooth insulating layer 200, both the electrodes being made of a transparent metal. In addition, an alignment layer 190 overlays the counter electrodes 160 to be aligned with the alignment layer 350 over the second substrate 310. A gate insulating layer 210 is sandwiched between scan signal lines and the first substrate 170.

In this embodiment, there are also a lateral electric field generated in a plane partly parallel with the substrate as that involved in the conventional liquid crystal display device and a vertical electric field generated in a plane substantially perpendicular to the substrate above the pixel electrodes 140, distributions of the electric fields being indicated by arrows shown in FIG. 3a. In addition, the smooth insulating layer 200 is capable of reducing the misalignment of the liquid crystals caused by the unevenness of surface. Moreover, the smooth insulating layer 200 is made of a material of low dielectric constant to avoid light leakage at the periphery of the pixel regions by indirectly reducing influence of power lines caused by metal lines on the bottom on the orientation of the liquid crystals.

### Embodiment 3

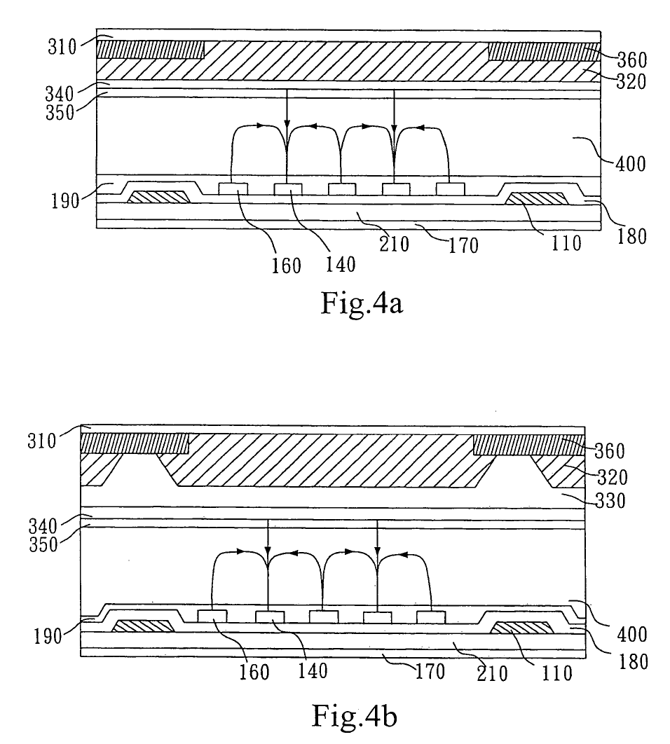

In this embodiment, a liquid crystal device is illustrated in FIG. 4a, in which a color filter 320, a transparent auxiliary electrode 340 and an alignment layer 350 are disposed in order over the surface of a second substrate 310. Furthermore, a black matrix 360 is interposed between the second substrate 310 and the color filter 320, being positioned around the periphery of each of pixel regions. This embodiment also comprises a smooth layer 330 sandwiched between the color filter 320 and the transparent auxiliary electrode 340, as shown in FIG. 4b. Pixel electrodes 140 and counter electrodes 160 are formed on the same level over the surface of a first substrate 170. The pixel electrodes 140 and video signal lines 110 sandwich an insulating layer 180, both the pixel electrodes 140 and the counter electrodes 160 being made of a transparent metal. In addition, an alignment layer 190 overlays the counter electrodes 160 to be aligned with the alignment layer 350 over the second substrate 310. A gate insulating layer 210 is sandwiched between scan signal lines and the first substrate 170.

In this embodiment, there are also a lateral electric field generated in a plane partly parallel with the substrate as that involved in the conventional liquid crystal display device and a vertical electric field generated in a plane substantially perpendicular to the substrate above the pixel electrodes 140, distributions of the electric fields being indicated by arrows shown in FIG. 4a. In addition, the pixel electrodes 140 and the counter electrodes 160 are formed on the same level so that they can be integrated into the same processing step to simplify the processing steps for electrodes. Moreover, both the pixel electrodes 140 and the counter electrodes 160 are spaced from the video signal lines 110 with the insulating layer 180 so as to reduce influence of common lines 150 and the video signal lines 110 on the liquid crystals.

### Embodiment 4

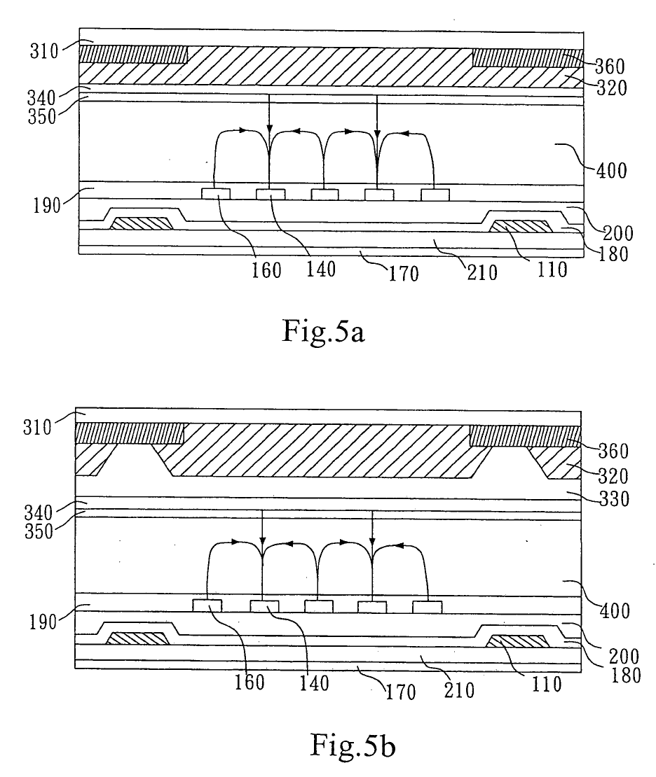

In this embodiment, a liquid crystal device is illustrated in FIG. 5a, in which a color filter 320, a transparent auxiliary electrode 340 and an alignment layer 350 are disposed in order over the surface of a second substrate 310. Furthermore, a black matrix 360 is interposed between the second substrate 310 and the color filter 320, being positioned around the periphery of each of pixel regions. This embodiment also comprises a smooth layer 330 interposed between the color filter 320 and the transparent auxiliary electrode 340, as shown in FIG. 5b. Pixel electrodes 140 and counter electrodes 160 are mounted on the same level over the surface of a first substrate 170. The pixel electrodes 140 and video signal lines 110 sandwich an insulating layer 180 and a smooth insulating layer 200, both the pixel electrodes 140 and the counter electrodes 160 being made of a transparent metal. In addition, an alignment layer 190 overlays the counter electrodes 160 to be aligned with the alignment layer 350 over the second substrate 310. A gate insulating layer 210 is sandwiched between scan signal lines and the first substrate 170.

In this embodiment, there are also a lateral electric field generated in a plane partly parallel with the substrate as that involved in the conventional liquid crystal display device and a vertical electric field generated in a plane substantially perpendicular to the substrate above the pixel electrodes 140, distributions of the electric fields being indicated by arrows shown in FIG. 5a. In addition, the pixel electrodes 140 and the counter electrodes 160 are formed on the same level. Moreover, both the pixel electrodes 140 and the counter electrodes 160 are spaced from the video signal lines 110 with the insulating layer 180 and the smooth insulating layer 200 so as to reduce influence of common lines 150 and the video signal lines 110 on the liquid crystals.

### Embodiment 5

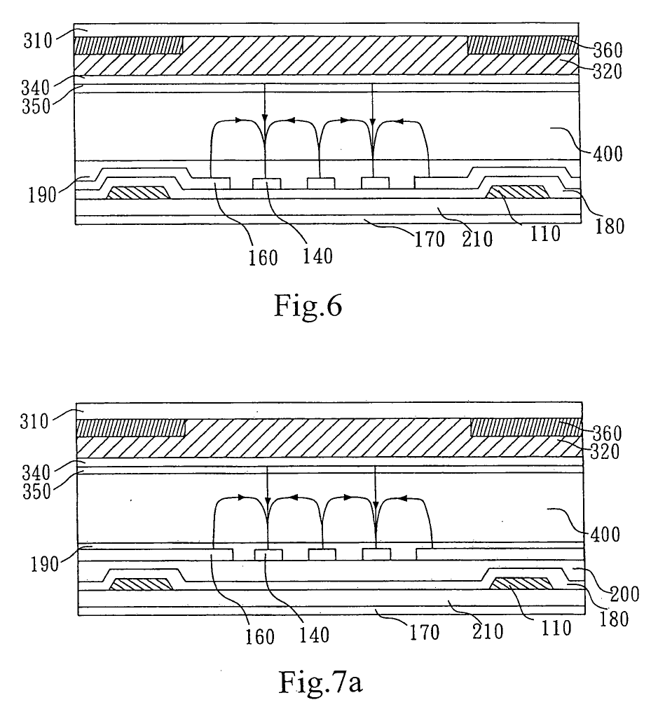

In this embodiment, a liquid crystal device is illustrated in FIG. 6a, in which a color filter 320, a transparent auxiliary electrode 340 and an alignment layer 350 are disposed in order over the surface of a second substrate 310. Furthermore, a black matrix 360 is interposed between the second substrate 310 and the color filter 320, being positioned around the periphery of each of pixel regions. Pixel electrodes 140 and counter electrodes 160 are formed on the same level over the surface of a first substrate 170. The pixel electrodes 140 and video signal lines 110 sandwich an insulating layer 180, both the pixel electrodes 140 and the counter electrodes 160 being made of a transparent metal. The counter electrodes 160 having portions adjacent to the video signal lines 110 are overlapped with the video signal lines so as to cover influence of power caused by the video signal lines 110 on a liquid crystal layer 400 by laying the counter electrodes 160 over the video signal lines 110. In addition, an alignment layer 190 overlays the counter electrodes 160 to be aligned with the alignment layer 350 over the second substrate 310. A gate insulating layer 210 is sandwiched between scan signal lines and the first substrate 170.

In this embodiment, there are also a lateral electric field generated in a plane partly parallel with the substrate as that involved in the conventional liquid crystal display device and a vertical electric field generated in a plane substantially perpendicular to the substrate above the pixel electrodes 140, distributions of the electric fields being indicated by arrows shown in FIG. 6a. In addition, because the counter electrodes 160 are partly overlapped with the video signal lines 110, more of the lateral electric fields are generated to increase the aperture ratio of the pixel regions.

### Embodiment 6

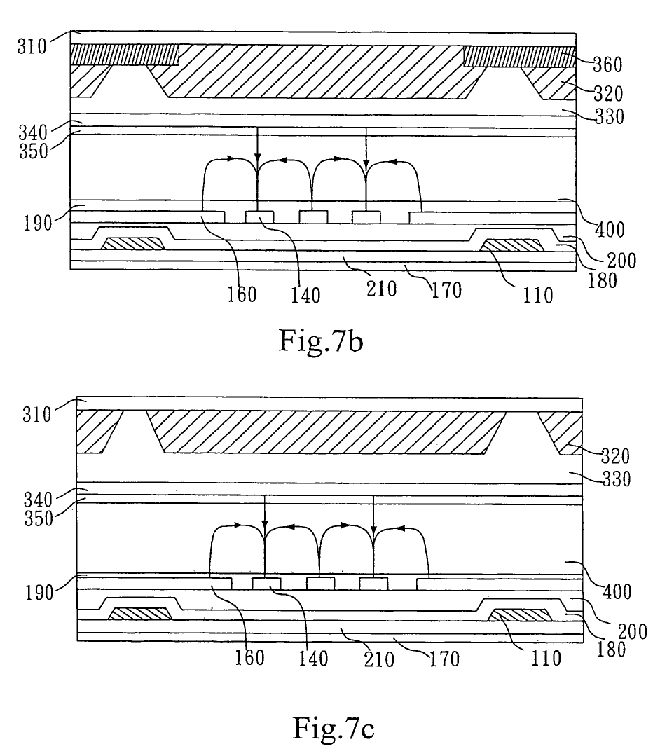

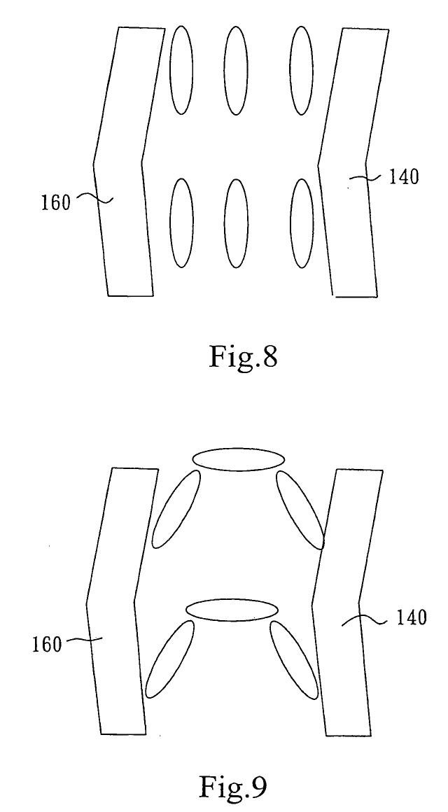

In this embodiment, a liquid crystal device is illustrated in FIG. 7a, in which a color filter 320, a transparent auxiliary electrode 340 and an alignment layer 350 are disposed in order over the surface of a second substrate 310. Furthermore, a black matrix 360 is interposed between the second substrate 310 and the color filter 320, being positioned around the periphery of each of pixel regions. This embodiment also further comprises a smooth layer 330 interposed between the color filter 320 and the transparent auxiliary electrode 340, as shown in FIG. 7b. This embodiment can further replace the black matrix by utilizing the crossings of various pixels to effect the light shielding around the periphery of the pixel regions, as shown in FIG. 7c.

Pixel electrodes 140 and counter electrodes 160 are formed on the same level over the surface of a first substrate 170. The pixel electrodes 140 and video signal lines 110 sandwich an insulating layer 180 and a smooth insulating layer 200, both the pixel electrodes 140 and the counter electrodes 160 being made of a transparent metal. The counter electrodes 160 having portions adjacent to the video signal lines 110 are overlapped with the video signal lines so as to cover influence of the video signal lines 110 on a liquid crystal layer 400 by having the counter electrodes 160 interposed between the liquid crystal layer 400 and the video signal lines 110. In addition, an alignment layer 190 overlays the counter electrodes 160 to be aligned with the alignment layer 350 over the second substrate 310. A gate insulating layer 210 is sandwiched between scan signal lines and the first substrate 170.

In this embodiment, there are also a lateral electric field generated in a plane partly parallel with the substrate as that involved in the conventional liquid crystal display device and a vertical electric field generated in a plane substantially perpendicular to the substrate above the pixel electrodes 140, distributions of the electric fields being indicated by arrows shown in FIG. 7a. In addition, because the counter electrodes 160 are partly overlapped with the video signal lines 110, more of the lateral electric fields are generated to increase the aperture ratio of the pixel regions. Moreover, the presence of the smooth insulating layer 200 can reduce influence of common lines 150 and the video signal lines 110 on the liquid crystals.

Although the present invention has been explained in relation to its preferred embodiments, it is to be understood that many other possible modifications and variations can be made without departing from the spirit and scope of the invention as hereinafter claimed.

What is claimed is:

1. A liquid crystal display device, comprising:
a first substrate having thin film transistors, video signal lines, scan signal lines, common lines, pixel electrodes and counter electrodes, wherein every two said video signal lines adjacent to each other and every two said scan signal lines adjacent to each other define a pixel region within which one of said adjacent video signal lines is electrically connected to the source of a thin film transistor within said pixel region, one of said adjacent scan signal lines is electrically connected to the gate of said thin film transistor within said pixel region, and one of said pixel electrodes of said pixel region is electrically connected to the drain of said thin film transistor within said pixel region, said common lines and said counter electrodes are electrically connected for controlling a voltage, and said pixel electrodes and said counter electrodes are alternately arranged so that starting points and end points of both said pixel electrodes and said counter electrodes are positioned on one side of said pixel region;
a second substrate having at least a transparent auxiliary electrode on the surface thereof; and
a liquid crystal layer interposed between said first substrate and said second substrate.

2. The liquid crystal display device of claim 1, wherein said second substrate further comprises a color filter interposed between said second substrate and said transparent auxiliary electrode.

3. The liquid crystal display device of claim 1, wherein a voltage applied to said transparent auxiliary electrode is equivalent to that applied to said counter electrodes.

4. The liquid crystal display device of claim 1, wherein said pixel electrodes or said counter electrodes are made of a transparent metal.

5. The liquid crystal display device of claim 4, wherein said transparent metal is indium-tin-oxide or indium-zinc-oxide.

6. The liquid crystal display device of claim 2, wherein said second substrate further comprises a smooth layer interposed between said color filer and said transparent auxiliary electrode.

7. The liquid crystal display device of claim 1, wherein said pixel electrodes and said counter electrodes are formed on the same plane.

8. The liquid crystal display device of claim 1, wherein an insulating layer is further included between said counter electrodes and said video signal lines.

9. The liquid crystal display device of claim 8, wherein a smooth insulating layer is further included between said counter electrodes and said insulating layer, and said scan signal lines and said common lines are positioned between said smooth insulating layer and said first substrate.

10. The liquid crystal display device of claim 9, wherein said smooth insulating layer is made of an organic material.

11. The liquid crystal display device of claim 8, wherein said insulating layer is made of an inorganic material.

12. The liquid crystal display device of claim 1, wherein said pixel electrodes and said counter electrodes are alternately arranged and have a strip or zigzag shape.

13. The liquid crystal display device of claim 1, wherein said counter electrodes having portions overlapped with said video signal lines in said pixel regions.

14. The liquid crystal display device of claim 1, wherein said liquid crystal layer is formed of a negative dielectric anisotropic liquid crystal or a positive dielectric anisotropic liquid crystal.

15. The liquid crystal display device of claim 1, wherein said transparent auxiliary electrode is indium-tin-oxide or indium-zinc-oxide.

16. A liquid crystal display device of claim 1, wherein said transparent auxiliary electrode is planarized or patterned.

17. The liquid crystal display device of claim 2, wherein a black matrix interposed between said second substrate and said color filter is further included within each of said pixel regions.

18. The liquid crystal display device of claim 1, wherein said first and second substrates further comprise an alignment layer for alignment of said first and second substrates to be assembled into said liquid crystal display device.
